(19) United States
(12) Patent Application Publication
(10) Pub. No.: US 2018/0207755 A1
(43) Pub. Date: Jul. 26, 2018

(54) GEAR MECHANISM ASSEMBLY APPARATUS AND ASSEMBLY METHOD

(71) Applicant: KAWASAKI JUKOGYO KABUSHIKI KAISHA, Kobe-shi, Hyogo (JP)

(72) Inventors: Hideshi YAMANE, Kakogawa-shi (JP); Jun TAKEBAYASHI, Kakogawa-shi (JP); Shuhei KURAOKA, Akashi-shi (JP); Hiroyuki MIZUMOTO, Kobe-shi (JP); Tatsuhiro UTO, Akashi-shi (JP); Shinichi FUJISAWA, Ashiya-shi (JP); Akio YODA, Takasago-shi (JP)

(73) Assignee: KAWASAKI JUKOGYO KABUSHIKI KAISHA, Kobe-shi, Hyogo (JP)

(21) Appl. No.: 15/577,082

(22) PCT Filed: May 12, 2016
(86) PCT No.: PCT/JP2016/064201

§ 371 Date: Nov. 27, 2017

(30) Foreign Application Priority Data
May 25, 2015 (JP) 2015-105080

(51) Int. Cl. B23P 19/04; B23P 21/00; B25J 9/16; F16H 57/00

(52) U.S. Cl. CPC B23P 19/04; B23P 21/00; F16H 2057/0043; B25J 9/1697; F16H 57/00; B25J 9/1687

(57) ABSTRACT

This apparatus has first and second imaging devices for imaging first and second gears; a robot having the first imaging device; and an image processing system for acquiring a fitting position of a second gear and a phase of a first gear by processing an image of the first imaging device, and for acquiring a phase of the second gear and a position of a gear shaft of the second gear by processing an image of the second imaging device. A gear mechanism is assembled by controlling the robot based on the information acquired by the image processing system so as to position the gear shaft of the second gear held by the hand to a fitting position of the second gear and also position the phase of the second gear to the phase of the first gear. The gear mechanism is easily assembled by fitting gears using the robot.

### TECHNICAL FIELD

The present invention relates to an assembly apparatus and an assembly method of a gear mechanism for fitting gears to each other so as to assemble the gear mechanism.

### BACKGROUND ART

Recently, at production sites, a system using a robot for assembly is broadly coming into practical in the production of products such as devices and machines for labor saving, automation, shortening of work hours, cost reduction, and the like. Since a fitting work such as insertion of a shaft into a shaft hole needs to be performed when assembling a product, various kinds of development have been made with regard to insertion and fitting of a shaft and the like using a robot.

In order to insert the shaft into the shaft hole, it is necessary to control operation of the shaft held by the robot so that the position and direction of the shaft to be inserted coincide with the position and direction of the shaft hole into which the shaft is inserted. Conventionally, RCC (Remote Center Compliance) mechanism has been used to realize such an operation by a mechanism. However, since the RCC makes the shaft follow a direction deviation of the shaft hole or the like so as to insert it using an elastic body such as a spring, it is difficult to deal with an assembly work directed in a lateral direction (lateral assembly work) not an assembly work directed downward in a vertical direction (longitudinal assembly work).

In contrast, in Patent Document 1, in a robot hand where a cushion mechanism portion, a RCC mechanism portion and a work chuck mechanism portion are joined to each other, the work chuck mechanism portion is incorporated inside the RCC mechanism portion. Thereby, hanging down of the RCC mechanism due to weight is reduced and not only lateral assembly work but also the longitudinal assembly work is possible.

### CITATION LIST

### Patent Document

[Patent Document 1] Japanese Patent Application Laid-Open No. H08-52682

### SUMMARY OF INVENTION

### Objects to be Achieved by the Invention

However, a conventional robot employing the aforementioned RCC is intended to insert a shaft having a simple circular cross section into a shaft hole having a simple circular cross section. Therefore, for example when gears are fitted to each other so as to assemble a gear mechanism, automation by a robot is extremely difficult or impossible.

The present invention is made considering the aforementioned problem of the conventional technique, and its object is to provide a gear mechanism assembly apparatus and assembly method capable of fitting gears to each other using a robot so as to assemble a gear mechanism without difficulty.

### Mean for Achieving the Objects

In order to achieve the objects above, a first aspect of the present invention is a gear mechanism assembly apparatus for assembling a gear mechanism by fitting a second gear to a first gear, comprising: a robot having a hand for holding the second gear; a first imaging device provided to the hand for imaging the first gear, a second imaging device for imaging the second gear; and an image processing system for acquiring a fitting position of the second gear and a phase of the first gear by processing an image imaged by the first imaging device, and for acquiring a phase of the second gear and a position of a gear shaft of the second gear by processing an image imaged by the second imaging device, wherein the gear mechanism is assembled using the robot by controlling the robot based on an information acquired by the image processing system so as to position the gear shaft of the second gear held by the hand to a fitting position of the second gear in the first gear and also position the phase of the second gear to the phase of the first gear.

A second aspect of the present invention is that, in the first aspect, the image processing system comprises a first image processing unit for processing an image of the first gear so as to detect an area of the first gear and acquiring the fitting position of the second gear in the first gear and the phase of the first gear based on the detected area of the first gear.

A third aspect of the present invention is that, in the second aspect, the first gear has a plurality of planetary gears, wherein the first image processing unit extracts a valley part of the plurality of planetary gears included in an imaged image based on the area of the first gear and sets a center of a circumscribed circle which is circumscribed to a plurality of circular arcs whose point on a circumference is a gravity center of the extracted valley part as the fitting position of the second gear in the first gear and also, on the basis of the center of the circumscribed circle, specifies a direction toward a gravity center of a valley part closest to a contact with the circumscribed circle in any one of the plurality of circular arcs as the phase of the first gear.

A fourth aspect of the present invention is that, in the second aspect, the first gear has a plurality of planetary gears, wherein the first image processing unit extracts a valley part of the plurality of planetary gears included in an imaged image of the first imaging device based on the area of the first gear and sets a center of a circumscribed circle which is circumscribed to a plurality of circular arcs whose point on a circumference is a gravity center of the extracted valley part as the fitting position of the second gear in the first gear and also, on the basis of the center of the circumscribed circle, specifies a direction toward a point on a circumference of the circumscribed circle such that a length on the circumscribed circle from a contact with the circumscribed circle in any one of the plurality of circular arcs is equal to a length on a circumference of the circular arc between a gravity center of a valley part existing closest to the contact in the circular arc and the contact as the phase of the first gear.

A fifth aspect of the present invention is that, in any one of the first to fourth aspects, the image processing system comprises a second image processing unit for processing an image of the second gear so as to detect an area of the second gear and acquiring a position of a distal end portion and a position of a root portion of the gear shaft of the second gear and the phase of the second gear based on the detected area of the second gear.

A sixth aspect of the present invention is that, in the fifth aspect, a shaft center direction of the second gear is acquired based on the position of the distal end portion and the position of the root portion of the gear shaft of the second gear acquired by the second image processing unit, and the robot is controlled so that a deviation of a holding position of the second gear by the hand is corrected based on the shaft center direction of the second gear.

A seventh aspect of the present invention is that, in the sixth aspect, after the position of the distal end portion and the position of the root portion of the gear shaft of the second gear are acquired by the second image processing unit, the hand is rotated by a previously set angle and the second gear is imaged again by the second imaging device, and the position of the distal end portion and the position of the root portion of the gear shaft of the second gear are acquired again by the second image processing unit based on a secondly imaged image, and then a shaft center direction of the second gear is acquired based on an information of the position of the distal end portion and the position of the root portion of the gear shaft of the second gear acquired over two times, and the robot is controlled so that a deviation of a holding position of the second gear by the hand is corrected based on the shaft center direction of the second gear.

An eighth aspect of the present invention is that, in any one of the first to seventh aspects, the second gear is provided to an output shaft of a motor, wherein the hand is configured to grasp the motor, and wherein an optical sensor for measuring a distance to an object to which the motor is mounted is provided to the hand.

A ninth aspect of the present invention is that, in any one of the first to eighth aspects, the gear mechanism is a planetary gear mechanism, in which the first gear is a planetary gear of the planetary gear mechanism and the second gear is a sun gear of the planetary gear mechanism.

A tenth aspect of the present invention is a gear mechanism assembly method for assembling a gear mechanism by fitting a second gear to a first gear using a robot, comprising: a first gear measuring step of acquiring a fitting position of the second gear in the first gear and a phase of the first gear; and a second gear measuring step of acquiring a phase of the second gear and a position of a gear shaft, wherein the gear mechanism is assembled using the robot by controlling the robot based on an information acquired by the first gear measuring step and the second gear measuring step so as to position the gear shaft of the second gear held by a hand of the robot to a fitting position of the second gear in the first gear and also position the phase of the second gear to the phase of the first gear.

An eleventh aspect of the present invention is that, in the tenth aspect, the first gear measuring step has a first image processing step of acquiring an image of the first gear using an imaging device provided to the hand and performing an image processing, wherein the first image processing step is configured to process an image of the first gear so as to detect an area of the first gear and to acquire the fitting position of the second gear in the first gear and the phase of the first gear based on the detected area of the first gear.

A twelfth aspect of the present invention is that, in the eleventh aspect, the first gear has a plurality of planetary gears, wherein, in the first image processing step, a valley part of the plurality of planetary gears included in an imaged image is extracted based on the area of the first gear, and a center of a circumscribed circle which is circumscribed to a plurality of circular arcs whose point on a circumference is a gravity center of the extracted valley part is set as the fitting position of the second gear in the first gear, and also, on the basis of the center of the circumscribed circle, a direction toward a gravity center of a valley part closest to a contact with the circumscribed circle in any one of the plurality of circular arcs is specified as the phase of the first gear.

A thirteenth aspect of the present invention is that, in the eleventh aspect, the first gear has a plurality of planetary gears, wherein, in the first image processing step, a valley part of the plurality of planetary gears included in an imaged image is extracted based on the area of the first gear, and a center of a circumscribed circle which is circumscribed to a plurality of circular arcs whose point on a circumference is a gravity center of the extracted valley part is set as the fitting position of the second gear in the first gear, and also, on the basis of the center of the circumscribed circle, a direction toward a point on a circumference of the circumscribed circle such that a length on the circumscribed circle from a contact with the circumscribed circle in any one of the plurality of circular arcs is equal to a length on a circumference of the circular arc between a gravity center of a valley part existing closest to the contact in the circular arc and the contact is specified as the phase of the first gear.

A fourteenth aspect of the present invention is that, in any one of the tenth to thirteenth aspects, the second gear measuring step has a second image processing step of acquiring an image of the second gear and performing an image processing, wherein, in the second image processing step, an image of the second gear is processed so as to detect an area of the second gear, and a position of a distal end portion and a position of a root portion of the gear shaft of the second gear and the phase of the second gear are acquired based on the detected area of the second gear.

A fifteenth aspect of the present invention is that, in the fourteenth aspect, a shaft center direction of the second gear is acquired based on the position of the distal end portion and the position of the root portion of the gear shaft of the second gear acquired by the second image processing step, and the robot is controlled so that a deviation of a holding position of the second gear by the hand is corrected based on the shaft center direction of the second gear.

A sixteenth aspect of the present invention is that, in the fifteenth aspect, after the position of the distal end portion and the position of the root portion of the gear shaft of the second gear are acquired in the second image processing step, the hand is rotated by a previously set angle and the second gear is imaged again, and the position of the distal end portion and the position of the root portion of the gear shaft of the second gear are acquired again based on a secondly imaged image, and then a shaft center direction of the second gear is acquired based on an information of the position of the distal end portion and the position of the root portion of the gear shaft of the second gear acquired over two times, and the robot is controlled so that a deviation of a holding position of the second gear by the hand is corrected based on the shaft center direction of the second gear.

A seventeenth aspect of the present invention is that, in any one of the tenth to sixteenth aspects, the second gear is provided to an output shaft of a motor, wherein the hand is configured to grasp the motor, and wherein a distance to an object to which the motor is mounted is measured by an optical sensor provided to the hand, and a base coordinate system in the object is generated based on the measurement result.

An eighteenth aspect of the present invention is that, in any one of the tenth to seventeenth aspects, the gear mechanism is a planetary gear mechanism, in which the first gear is a planetary gear of the planetary gear mechanism and the second gear is a sun gear of the planetary gear mechanism.

### Effect of the Invention

According to the present invention, a gear mechanism assembly apparatus and assembly method capable of fitting gears to each other using a robot so as to assemble a gear mechanism without difficulty can be provided.

### BRIEF DESCRIPTION OF THE DRAWINGS

FIG. 1 illustrates a schematic configuration of a gear mechanism assembly apparatus according to one embodiment of the present invention.

FIG. 2 is a schematic chart illustrating a method for calculating a target position to be a shaft center of a motor side gear after assembly in a planetary gear and a phase of the planetary gear according to a first image processing portion of the embodiment in FIG. 1.

FIG. 3 illustrates a method for calculating a phase of the motor side gear for accurately positioning a phase of a reducer gear and the phase of the motor side gear, using the embodiment in FIG. 1.

FIG. 4 illustrates a correction method of a distal end portion center position of an output shaft based on calculated coordinate values P, P′ of the distal end portion center position of the output shaft, using the embodiment in FIG. 1.

### EMBODIMENT OF THE INVENTION

Hereunder, a gear mechanism assembly apparatus according to one embodiment of the present invention and a gear mechanism assembly method using the assembly apparatus will be described referring to the drawings.

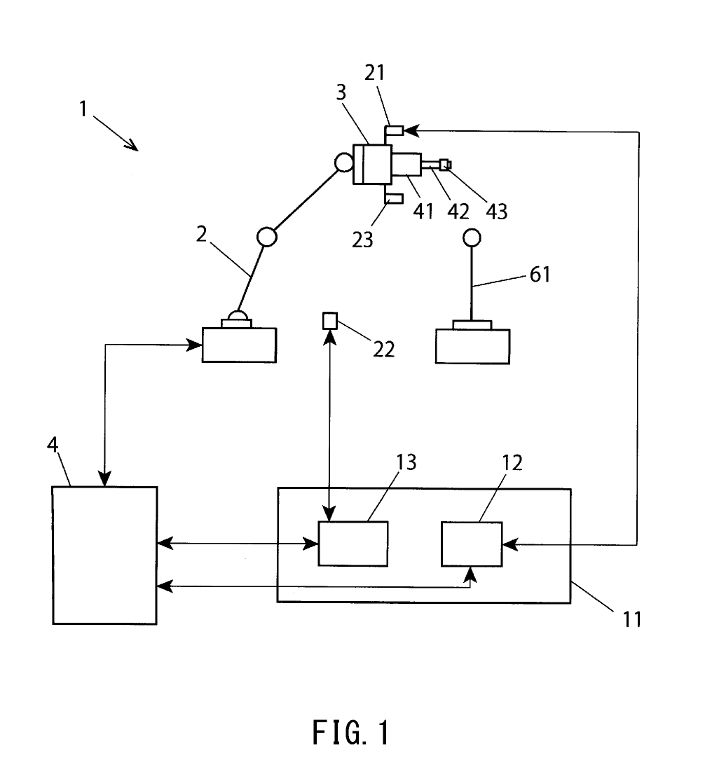

As illustrated in FIG. 1, a gear mechanism assembly apparatus 1 according to this embodiment comprises a robot used to assemble gears (hereunder, referred to as “working robot”) 2, a hand 3 mounted to a wrist portion of the working robot 2 for grasping a work, a robot control device 4 for controlling operation of the working robot 2, an image processing system 11, a first imaging device 21, and a second imaging device 22.

Further, an optical sensor 23 consisting of a laser distance sensor or the like is mounted to the hand 3. Distance to an object to which a work is mounted or the like can be measured using the optical sensor 23.

The image processing system 11 comprises a first image processing portion 12 for processing an image imaged by the first imaging device 21 and a second image processing portion 13 for processing an image imaged by the second imaging device 22. Note that the first image processing portion 12 and the second image processing portion 13 may be completely independent apparatus as hardware, or they may be arranged in an integrated apparatus as hardware and configured as subcomponents while having a partially common element in the apparatus. Further, they may be configured as sub components even when they have a partially common element as software while they are integrated as hardware inside the apparatus.

In this embodiment, the working robot 2 uses an articulated robot having six axes and the robot control device 4 performs control of an arbitrary position and direction in the space and an operation path and of the wrist portion. However, the working robot in this invention is not limited to the six-axis articulated robot.

A CCD camera or the like is used as the first imaging device 21 and the second imaging device 22.

A gear mechanism to be assembled in this embodiment is a mechanism having one sun gear arranged in the center and three planetary gears around the sun gear. However, a gear mechanism which can be assembled by the gear mechanism assembly apparatus according to this invention is not limited to the gear mechanism in this configuration.

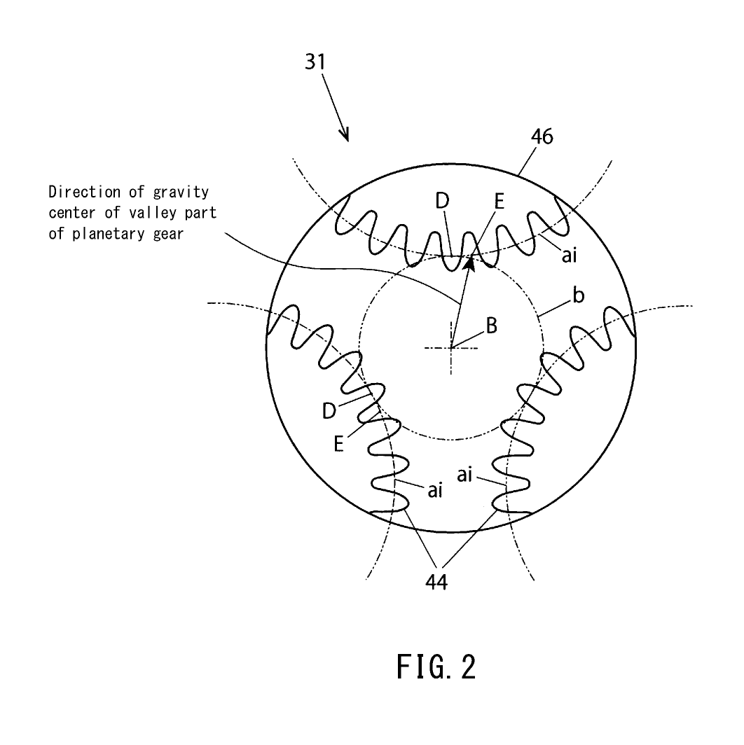

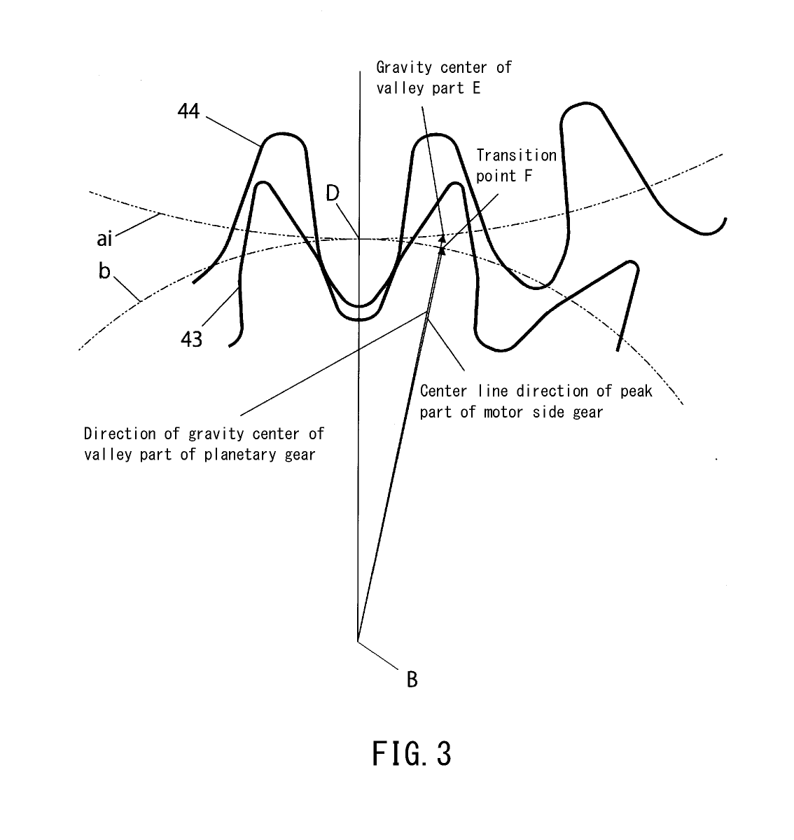

A gear assembly apparatus 1 according to this embodiment performs a work for assembling a reducer gear 31 and a motor side gear 43 by for example fitting a motor side gear 43 (FIG. 3) mounted to an output shaft 42 of a motor 41 to the reducer gear 31 (FIG. 2) already incorporated to a drive shaft of a robot which is being manufactured and assembled (hereunder, referred to as “product robot”) 61, and inserting the output shaft 42 into the reducer gear 31.

Accordingly, a shaft direction of the output shaft 42 of the motor 41 mounted to the drive shaft of the product robot 61 is not limited to the vertical direction and is frequently arranged in the horizontal direction in general. Therefore, the work for combining the motor side gear 43 of the motor 41 having the output shaft 42 arranged in the horizontal direction with the reducer gear 31 by the working robot 1 is the lateral assembly work.

Further, since the motor side gear 43 is integrated with the output shaft 42 and the motor 41, a work to be grasped by the hand 3 of the working robot 1 is extremely heavy in general. This embodiment can handle the case when a work including a gear to be combined is highly heavy and the working robot performs assembly of gears by the lateral assembly work as above without difficulty.

As illustrated in FIG. 2, in the gear mechanism in this embodiment, a planetary gear 44 incorporating the motor side gear 43 mounted to the output shaft 42 of the motor 41 is incorporated in a casing of the reducer, and it is seen from the outside of the casing only via an insertion hole 46 for inserting the output shaft 42 into the casing.

In order to fit and assemble the motor side gear 43 to the planetary gear 44, it is necessary to cause a shaft center of a distal end portion of the output shaft 42 to coincide with a target position to be a shaft center of the motor side gear 43 after assembly in the planetary gear 44, and also it is necessary to adjust the angle of the output shaft 42 in a direction that the phase of the motor side gear 43 corresponds to the phase of the planetary gear 44 and insert and incorporate the output shaft 42 inside the planetary gear 44.

Accordingly, in this embodiment, first, the target position to be the shaft center of the motor side gear 43 after assembly in the planetary gear 44 and the phase of the planetary gear 44 are measured.

Hereunder, a method for measuring the target position to be the shaft center of the motor side gear 43 after assembly in the planetary gear 44 and the phase of the planetary gear 44 will be described in detail. Note that, hereunder, these two amounts to be measured will be referred to as “characteristic information of reducer gear”.

Before the assembly work of gears, an image including the reducer gear 31 is imaged through the insertion hole 46 by the first imaging device 21 mounted to the hand 3 of the working robot 2, and the image imaged by the first imaging device 21 is processed in the first image processing portion 12 of the image processing system 11 so as to calculate the characteristic information of reducer gear.

The measurement of the characteristic information of reducer gear is started by a command signal from the robot control device 4 to the first image processing portion 12, and the first image processing portion 12 which received the command signal sends an imaging command signal to the first imaging device 21 and imaging is performed by the first imaging device 21. The imaged image is, as mentioned above, sent to the first image processing portion 12 from the first imaging device 21 and processed, and the calculated value is sent to the robot control device 4.

<Calculation Method of Characteristic Information of Reducer Gear>

Of the characteristic information of reducer gear, the target position to be the shaft center of the motor side gear 43 after assembly in the planetary gear 44 is calculated and specified as a point equidistant from every planetary gear 44 in an area enclosed by every planetary gear 44.

By inserting the motor side gear 43 inside the reducer gear 31 such that a valley part of the reducer gear 31 coincides with a peak part of the motor side gear 43, the both gears can be fitted to each other. This can be performed by, on the basis of the target position to be the shaft center of the motor side gear 43 after assembly in the planetary gear 44, measuring a direction of the valley part of the planetary gear 44 (hereunder referred to as “phase of planetary gear” or “phase of reducer gear”) and basically adjusting and positioning a direction of the peak part of the motor side gear 43 (hereunder referred to as “phase of motor side gear”) to the direction of the phase of the planetary gear 44 measured as above.

Here, for an accurate positioning, it is necessary to select a particular position regarding the valley part of the planetary gear 44. This particular position may be a middle point of a valley part of a pitch circle, for example. However, in this embodiment, it is the center of gravity of the valley part of the planetary gear 44 considering easiness of image processing and the like. Note that the same applies to a particular position regarding the peak part of the motor side gear 43 to be inserted, and it may be a middle point of a peak part of a pitch circle of the gear, while it is basically a direction of the center line of the peak part of the axisymmetric gear.

Hereunder, a calculation method of the phase of the reducer gear 31 by the first image processing portion 12 will be described in order of processing based on FIG. 2.

(1) Area Detection of Planetary Gear 44

An outline of a part of the planetary gear 44 is extracted using an image processing unit such as banalization of an imaged image or the like, and an area of the planetary gear 44 is detected by pattern matching with a shape of the planetary gear 44 which was previously stored. Note that the area of the planetary gear 44 is a part enclosed by a boundary line in a tooth shape of the planetary gear 44 and a circular arc of the insertion hole 46, in FIG. 2.

(2) Calculation of Circular Arc Passing Gravity Center of Valley Part of Planetary Gear 44

Based on the area of the planetary gear 44 detected by the aforementioned (1), a plurality of valley parts existing in the detected area are extracted and positions of gravity centers E of the extracted plurality of valley parts are calculated. After that, three circular arcs aᵢ (i=1, 2, 3) passing these positions of the gravity centers E are calculated.

(3) Calculation of Circumscribed Circle b of Three Circular Arcs aᵢ

A circumscribed circle b circumscribed to all of the three circular arcs ai calculated as aforementioned (2) and its center point B are calculated. The center point B is a target position to be the shaft center of the motor side gear 43 after assembly in the planetary gear 44.

The circumscribed circle b corresponds to the motor side gear 43 to be fitted to the planetary gear 44 and the center point B corresponds to the shaft center of the motor side gear 43. Therefore, hereunder, sometimes the circumscribed circle b is referred to as “motor side gear insertion shaft hole”, and the center point B of the circumscribed circle is referred to as “insertion shaft hole shaft center”.

Note that, the case when the planetary gear mechanism has three planetary gears is described above, while, even when the planetary gear mechanism has four or more planetary gears, the circumscribed circle b and the center point B of the circumscribed circle b can be calculated in the same manner as above so as to acquire the target position to be the shaft center of the motor side gear 43 after assembly in the planetary gear 44.

Moreover, in a case when the planetary gear mechanism has two planetary gears, the circumscribed circle b and its center point B can be calculated by the method below.

Two circular arcs are calculated and center points of the two circular arcs are calculated in the same manner as above. Next, (two) intersections of a line segment connecting these two centers of the circular arcs and the two circular arcs are calculated, and the circle b whose diameter is these two intersections and whose center B is a center of a line segment connecting the two intersections is calculated. Thereby, the circumscribed circle b and its center B can be obtained.

Calculation of Direction from Center Point B to Gravity Center E of Valley Part Closest from Contact D of Circular Arc aᵢ and Circumscribed Circle b

One circular arc is selected from the three circular arcs a₁, and the gravity center E closest from a contact D of the selected circular arc aᵢ and circumscribed circle b is selected so as to calculate the direction from the center point B of the circumscribed circle b to the gravity center E. On the basis of the shaft center of the motor side gear 43, the direction BE is the direction of the valley of the planetary gear 44, and therefore it can approximates the direction of the center line of the peak part of the motor side gear (center line of the peak part of the axisymmetric gear) to be inserted and fitted into the motor side gear insertion shaft hole. Thereby, when incorporating the motor side gear 43 into the motor side gear insertion shaft hole of the planetary gear 44, it can be adjusted and inserted such that the center line direction of the peak part of the gear of the motor side gear 43 is the direction BE calculated as above.

However, depending on shapes and dimensions of the planetary gear, there is a case when a gap between the center line direction of the peak part of the motor side gear 43 and the direction of the gravity center of the valley part of the planetary gear 44 (direction BE) based on the insertion shaft hole shaft center becomes large due to (mutual) relation of pitch of the gear, a pitch circle, and the like, and it becomes difficult to fit the both gears to each other even when making the center line direction of the peak part of the motor side gear 43 coincide with the direction of the gravity center of the valley part of the planetary gear 44 and inserting the motor side gear 43 into the planetary gear 44.

In such a case, the motor side gear 43 is incorporated into the planetary gear 44 by adjusting the direction of the motor side gear 43 to be inserted into the planetary gear 44 to a direction derived from the method below, not to the direction of the gravity center of the valley part of the planetary gear 44.

Thus, as illustrated in FIG. 3, a length DE between the contact D on the circumference of the circular arc aᵢ and the gravity center E is calculated, and a point F whose distance from the contact D on the circumference of the circumscribed circle is equal to the aforementioned length DE on the circumference is calculated. And when incorporating the motor side gear 43 into the motor side gear insertion shaft hole of the planetary gear 44, it can be adjusted and inserted such that the center line direction of the peak part of the gear of the motor side gear 43 is the direction BF calculated as above. Thereby, the motor side gear 43 and the planetary gear 44 can be fitted to each other even when the distance between the contact D and the gravity center E is large.

<Measurement of Motor Side Gear>

In the assembly work of gears using the working robot, the motor 41 placed on a placing table is grasped by the hand 3 for the assembly work, and therefore the grasping positions of the motor 41 by the hand 3 are displaced from each other in each work. Due to this displacement of grasping position, displacement occurs in the center position of the distal end portion and the axis direction of the output shaft 42 of the motor 41. Additionally, since the phase of the motor side gear 43 placed on the placing table is arbitrary, the phase of the motor side gear 43 is not specified in a state immediately after it is grasped by the hand 3.

Therefore, for fitting and assembling the motor side gear 43 to the reducer gear 31, it is necessary to measure the displacement of the center position of the distal end portion and the axis direction of the output shaft 42 and the phase of the motor side gear 43 and, based on the measurement information, control the operation of the working robot 2 so that the distal end portion position and the axis direction of the output shaft 42 and the phase of the motor side gear 43 coincide with the insertion shaft hole shaft center and the insertion shaft hole axis direction in the reducer gear 31 and the phase of the planetary gear 44, respectively.

The measurement of the motor side gear 43 is started by a command signal from the robot control device 4 to the second image processing portion 13, and the second image processing portion 13 which received the command signal sends an imaging command signal to the second imaging device 22, and then imaging is performed by the second imaging device 22. At this time, the working robot 1 moves the motor 41 grasped by the hand 3 to a visual range of the second imaging device 22. An imaged image is sent from the second imaging device 22 to the second image processing portion 13 and the phase of the motor side gear 43 or the like which is calculated by image processing is sent to the robot control device 4.

The displacement of the center position of the distal end portion and the axis direction of the output shaft 42 and the phase of the motor side gear 43 calculated by the second image processing portion 13 are sent to the robot control device 4 of the working robot 2 and used for resetting a tool coordinate system and executing operation control of the motor side gear 43.

Here, the tool coordinate system of the working robot 2 in this embodiment is set as a coordinate system whose XY coordinate plane is a plane of a root portion of the motor 41 of the output shaft 42 and whose Z coordinate axis is the axis of the output shaft 42 (direction toward the output shaft distal end portion is normal direction), and when incorporating the motor side gear 43 into the reducer gear 31, control is performed so that the motor 41 grasped by the working robot 2 is operated in the Z axis direction of the tool coordinate system.

Note that a calculation method of the phase of the motor side gear 43 and the distal end portion center position and the root portion center position of the output shaft 42 in the second image processing portion 13 will be described in <Correction method of shaft center direction of output shaft 42> below in detail.

<Correction Method of Shaft Center Direction of Output Shaft 42>

Hereunder, a method for measuring the phase of the motor side gear 43 and measuring the displacement of the distal end portion center position and the axis direction of the output shaft 42 so as to correct the shaft center direction of the output shaft 42 based on the measurement result will be described in detail, including the image processing method by the second image processing portion 13.

(1) Measurement of Distal End Portion Center Position of Output Shaft 42 and Phase of Motor Side Gear 43

The working robot 2 is operated so as to move the hand 3 to a position that the distal end of the output shaft 42 is directed to the second imaging device 22 and the axis of the output shaft 42 substantially coincides with a lens optical axis of the second imaging device 22 wherein the position is away from the second imaging device 22 at a distance longer than at least the length of the output shaft

After that, the second imaging device 22 images so that the distal end portion of the output shaft 42 and the motor side gear 43 are included in the visual range. The image acquired by the second imaging device 22 is sent to the second image processing portion 13 and a distal end portion center position P of the output shaft 42 and the phase of the motor side gear 43 are calculated by the second image processing portion 13.

A calculation method of the distal end portion center position of the output shaft 42 and the phase of the motor side gear 43 by the second image processing portion 13 will be described below.

(i) Calculation of Distal End Portion Center Position of Output Shaft 42

First, an outline of the motor side gear 43 is extracted using the banalization processing or other methods, and an area of the motor side gear 43 is detected by pattern matching with a shape of the motor side gear 43 which was previously stored. After that, the distal end portion center position P of the output shaft 42 is calculated based on the detected area of the motor side gear 43.

(ii) Calculation of Phase of Motor Side Gear 43

Based on the area of the motor side gear 43 detected by the aforementioned (1), the peak part of the motor side gear 43 is detected and a vertex N of a particular peak part is selected, and a direction PN from the distal end portion center position P calculated by the aforementioned (i) to the selected vertex N is generated. This direction PN is the phase of the motor side gear 43.

(2) Calculation of Center Position of Root Portion of Output Shaft 42

After operating the working robot 2 so as to make the motor 41 retreat a distance corresponding to the length of the output shaft 42 in a direction away from the second imaging device 22 in the axis direction of the output shaft 42, the second imaging device 22 images so that the root portion of the output shaft 42 is included in the visual range. The image acquired by the second imaging device 22 is sent to the second image processing portion 13, where an outline of the root portion of the output shaft 42 is extracted using a method such as the banalization processing by the second image processing portion 13, and a root portion center position Q of the output shaft 42 is calculated utilizing the shape characteristic that a sectional shape of the root portion is circular.

(3) Correcting Shaft Center Direction of Output Shaft 42

(3-1) Measurement of Distal End Portion Center Position of Output Shaft 42 (Re-Measurement)

When the working robot 2 is made to perform the work of incorporating the motor side gear 43 into the reducer gear 31, the aforementioned tool coordinate system is set in order to control the operation of the assembly robot 2 such that the distal end portion center and the shaft center of the output shaft 42 coincide with the insertion shaft hole shaft center and the insertion shaft hole shaft center direction of the reducer hear 31.

After rotating the motor 41 grasped by the hand 3 of the working robot 2 by a previously set angel θ about the aforementioned tool coordinate system Z axis, the attitude is maintained while the working robot 2 is operated so as to move the hand 3 to the measurement position in the aforementioned (1). After that, the second imaging device 22 images so that the distal end portion of the output shaft 42 and the motor side gear 43 are included in the visual range.

The imaged image is processed by the second image processing portion 23, wherein the outline of the motor side gear 43 is extracted using the banalization processing or other methods, and the area of the motor side gear 43 is detected by pattern matching with the shape of the motor side gear 43 which was previously stored. After that, a remeasured distal end portion center position P′ of the output shaft 42 is calculated based on the detected area of the motor side gear 43.

(3-2) Measurement of Root Portion of Output Shaft 42

After operating the working robot 2 so as to make the motor 41 retreat a distance corresponding to the length of the output shaft 42 in a direction away from the second imaging device 22 in the axis direction of the output shaft 42, the second imaging device 22 images so that the root portion of the output shaft 42 is included in the visual range. The imaged image is processed by the second image processing portion 23, wherein the outline of the root portion of the output shaft 42 is extracted using a method such as the banalization processing, and a remeasured root portion center position Q′ of the output shaft 42 is calculated utilizing that the sectional shape of the root portion is circular.

(3-3) Calculation of Accurate Axis Direction of Output Shaft 42

When the motor 41 grasped by the hand 3 of the working robot 2 is rotated about the tool coordinate system Z axis by the angle θ, a point existing on the tool coordinate system Z axis as a rotation center is physically invariant, and therefore its position in the image imaged by the second imaging device 22 is invariant as well. Accordingly, it is also invariant in the camera coordinate system (coordinate system whose XY plane is an imaging plane of CCD of a CCD camera or the like and whose origin is the center of the imaging plane)

However, a point which does not exist on the Z axis is rotationally displaced (moved) accompanying the rotation about the Z axis and its moving amount is increased and decreased according to increase and decrease of distance from the Z axis. As a result, a measured coordinate value in the camera coordinate system is also moved.

Then, utilizing this physical characteristics, a displacement amount of the point to be measured from the tool coordinate system Z axis can be calculated based on the measured value of moving mount of the point to be measured when the motor 41 is rotated about the tool coordinate system Z axis by the angle θ. In this embodiment, an accurate axis direction of the output shaft 42 is calculated based on the calculated displacement amount.

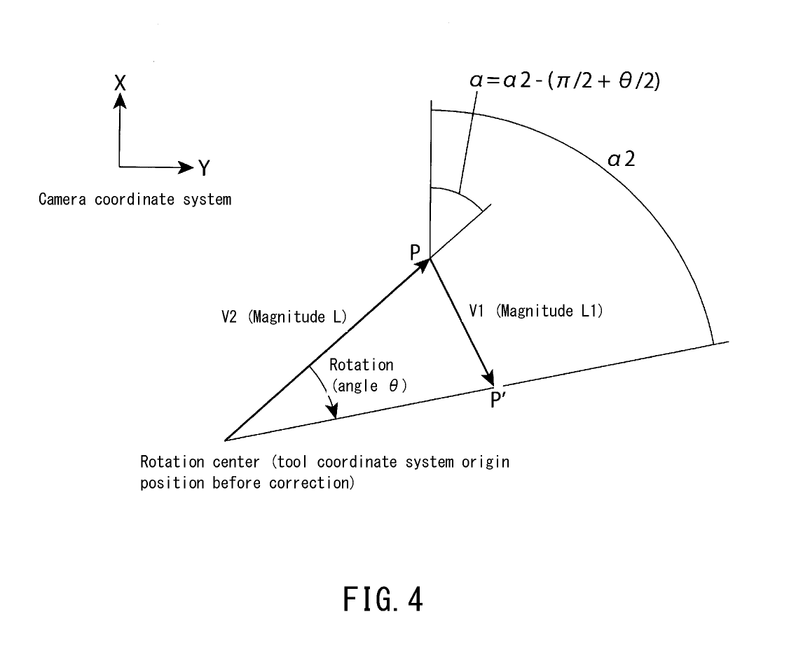

A method for calculating a more accurate shaft center direction of the output shaft 42 utilizing the coordinate values of the distal end portion center position and the root portion center position of the output shaft 42 reacquired according to the aforementioned (4) and (5) will be described below in detail referring to FIG. 4.

(i) Correction of Distal End Portion Center Position of Output Shaft 42 Based on Calculated Coordinate Values P, P′

When the motor 41 grasped by the hand 3 of the working robot 2 is rotated about the tool coordinate system Z axis by the angle θ, the XY coordinate value of the camera coordinate system of the distal end portion center position of the output shaft 42 is moved (displaced) from P to P′ as illustrated in FIG. 4, provided that the distal end portion center of the output shaft 42 does not exist on the tool coordinate system Z axis. When a moving vector from P to P′ in the camera coordinate system is referred to as a vector V₁, the vector V₁ can be calculated from the calculated coordinate values of P, P′.

Thus, a vector V₂ from P to the tool coordinate system origin can be obtained by a method below using the vector V₁ and θ based on FIG. 4, and therefore the accurate distal end portion center position of the output shaft 42 can be obtained by synthesizing the vector V₂ to the distal end portion center position of the output shaft 42 in the current tool coordinate system.

Thus, first, the vector V₁ (magnitude: L₁, angle from camera coordinate system X axis: α₂) is calculated from the coordinated values of P, P′, and then, by using the calculated values, a the vector V₂ (magnitude: L, angle from camera coordinate system X axis: α) from the tool coordinate system origin to P is obtained by the following formula.

L=L₁/(2·sin(θ/2))

α=α₂−(π/2+θ/2)

By synthesizing the vector V₂ obtained as above to the current tool coordinate system origin position, the accurate distal end portion center position P* of the output shaft 42 is calculated.

(ii) Correction of Root Portion Center Position of Output Shaft 42 Based on Calculated Coordinate Values Q, Q′

The root portion center position of the output shaft 42 is also corrected based on the calculated coordinate values Q, Q′ in the same manner as the aforementioned (i) so as to calculate the accurate root portion center position Q* of the output shaft 42.

(iii) Calculation of Accurate Shaft Center Direction of Output Shaft 42 of Motor 41

The accurate shaft center direction of the output shaft 42 is calculated based on P* and Q* calculated in the aforementioned (i) and (ii).

(3-4) Correcting Shaft Center Direction of Output Shaft 42

Based on the accurate root portion center position Q* and distal end portion center position P* and the accurate shaft center direction C* of the output shaft 42 calculated as above, a new tool coordinate system is set so that Q* is the tool coordinate system origin and C is the tool coordinate system Z axis.

<Assembly Method of Motor Side Gear and Reducer Gear>

An assembly method of the motor side gear 43 and the reducer gear based on a gear assembly apparatus according to this embodiment will be described in detail below.

(1) Measurement of Motor Mounting Plane

The working robot 1 is driven in a state that the hand 3 does not grasp the motor 41, and a position (robot base coordinate system) of a plane (for example, surface of an arm member of the product robot 61) to which the motor 41 is mounted is generated using the optical sensor (such as laser distance sensor) 23 mounted to the hand 3. Thus, a plane passing three points detected by the optical sensor 23 is calculated so as to determine a plane inclination (insertion shaft direction) in the robot base coordinate system.

(2) Measurement of Center Position of Motor Fitting Portion

An edge of a motor fitting portion (circular insertion port) with high machining accuracy in a member to which the motor 41 is mounted (for example, arm member of product robot 61) is sensed by the above-mentioned optical sensor (distance sensor) 23. At this time, the hand 3 of the working robot 2 monitors a distance sensor read value and detect a step part while moving from the inside toward to the outside. Here, the sensing is performed in two steps of a rough sensing from the inside toward the outside and a detailed sensing from the outside toward the inside for improving processing speed.

The center position of a circle passing three positions detected by the above-mentioned sensing (robot base coordinate system) is calculated so as to specify the center position of the motor fitting portion.

(3) Measurement of Motor Mounting Hole

A bolt hole (hole into which a bolt for fixing the motor 41 to an object member is screwed) formed in the object member to which the motor is mounted is measured by a CCD camera (first imaging device 21 may also be used as the camera) mounted to the working robot 2 so as to determine a final set rotation position.

Then, a coordinate (base coordinate system) is generated, whose XY plane is the plane obtained in the above-mentioned (1), whose insertion position is the center position obtained in the above-mentioned (2), and whose X axis is a direction from the center position obtained in the above-mentioned (2) to the bolt hole center position detected in the above-mentioned (3).

(4) Measurement of Phase of Reducer Gear 31 and Positions of Motor Side Gear Insertion Shaft Hole and Insertion Shaft Hole Shaft Center

The hand 3 of the working robot 2 is brought close to the vicinity of the drive shaft of the product robot 61, and the situation of the inside of the insertion hole 46 is imaged by the first imaging device 21 mounted to the hand 3 from the insertion hole 46 of the motor 31 provided to the drive shaft. Then, the phase of the reducer gear 31 and the positions of the motor side gear insertion shaft hole and the insertion shaft hole shaft center are calculated by image processing using the first image processing portion 22.

Note that, the characteristic information of the reducer gear calculated by the first image processing is sent to the robot control device 4 of the working robot 2.

Grasp of Motor 31 by Hand 3 of Working Robot 2

The motor 31 placed on the placing table is grasped by the hand 3 of the working robot 2. Since a positioning pin is provided to the hand 3 or the motor 31, the motor 31 is grasped by the hand 3 at a predetermined accuracy.

(6) Detection of Phase of Motor Side Gear 43, Measurement of Distal End Portion Center Position and Root Portion Center Position of Output Shaft 42, and Measurement of Shaft Center Direction of Output Shaft 42

The output shaft 42 of the motor 31 grasped by the hand 3 of the working robot 2 is imaged by the second imaging device and the imaged image is processed by the second image processing portion 23. Thereby, the detection of the phase of the motor side gear 43 and the measurement of the distal end portion center position and the root portion center position of output shaft 42 are performed.

(7) Setting Change of Tool Coordinate System Based on Measurement Result of Shaft Center Direction of Output Shaft 42

Based on the measurement result of the shaft center direction of the output shaft 42 calculated by the second image processing portion 23, setting of the tool coordinate system is changed.

(8) Performing Assembly of Gears by Operation Control of Assembly Robot 2 Based on Setting-Changed Tool Coordinate System

By the operation control of the assembly robot 2 based on the setting-changed tool coordinate system, assembly of gears is performed wherein the motor side gear 43 is fitted to the reducer side gear 31.

As mentioned above, gears can be fitted to each other by the working robot 2 without difficulty using the assembly apparatus 1 for gear mechanism according to this embodiment.

### DESCRIPTION OF REFERENCE NUMERALS

1 . . . assembly apparatus of gear mechanism
2 . . . working robot
3 . . . hand
4 . . . robot control device
11 . . . image processing system
12 . . . first image processing portion
13 . . . second image processing portion
21 . . . first imaging device
22 . . . second imaging device
23 . . . optical sensor (distance sensor)
31 . . . reducer gear (first gear)
41 . . . motor
42 . . . output shaft
43 . . . motor side gear (second gear)
44 . . . planetary gear
46 . . . insertion hole
61 . . . product robot
C . . . center of circumscribed circle b
D . . . contact of circler arc a and circumscribed circle b
E . . . gravity center of valley part of planetary gear
F . . . gravity center of peak part of motor side gear
a . . . circular arc passing gravity center of valley part of planetary gear
b . . . circumscribed circle circumscribed to circular arc a

1. A gear mechanism assembly apparatus for assembling a gear mechanism by fitting a second gear to a first gear, comprising:
a robot having a hand for holding the second gear;
a first imaging device provided to the hand for imaging the first gear,
a second imaging device for imaging the second gear, and
an image processing system for acquiring a fitting position of the second gear and a phase of the first gear by processing an image imaged by the first imaging device, and for acquiring a phase of the second gear and a position of a gear shaft of the second gear by processing an image imaged by the second imaging device,
wherein the gear mechanism assembly apparatus is configured such that the gear mechanism is assembled using the robot by controlling the robot based on an information acquired by the image processing system so as to position the gear shaft of the second gear held by the hand to a fitting position of the second gear in the first gear and also position the phase of the second gear to the phase of the first gear.

2. The gear mechanism assembly apparatus according to claim 1, wherein the image processing system comprises a first image processing unit for processing an image of the first gear so as to detect an area of the first gear and acquiring the fitting position of the second gear in the first gear and the phase of the first gear based on the detected area of the first gear.

3. The gear mechanism assembly apparatus according to claim 2,
wherein the first gear has a plurality of planetary gears, and
wherein the first image processing unit extracts a valley part of the plurality of planetary gears included in an imaged image based on the area of the first gear and sets a center of a circumscribed circle which is circumscribed to a plurality of circular arcs whose point on a circumference is a gravity center of the extracted valley part as the fitting position of the second gear in the first gear and also, based on the center of the circumscribed circle, specifies a direction toward a gravity center of a valley part closest to a contact with the circumscribed circle in any one of the plurality of circular arcs as the phase of the first gear.

4. The gear mechanism assembly apparatus according to claim 2,
wherein the first gear has a plurality of planetary gears, and
wherein the first image processing unit extracts a valley part of the plurality of planetary gears included in an imaged image of the first imaging device based on the area of the first gear and sets a center of a circumscribed circle which is circumscribed to a plurality of circular arcs whose point on a circumference is a gravity center of the extracted valley part as the fitting position of the second gear in the first gear and also, on based on the center of the circumscribed circle, specifies a direction toward a point on a circumference of the circumscribed circle such that a length on the circumscribed circle from a contact with the circumscribed circle in any one of the plurality of circular arcs is equal to a length on a circumference of the circular arc between a gravity center of a valley part existing closest to the contact in the circular arc and the contact as the phase of the first gear.

5. The gear mechanism assembly apparatus according to claim 1, wherein the image processing system comprises a second image processing unit for processing an image of the second gear so as to detect an area of the second gear and acquiring a position of a distal end portion and a position of a root portion of the gear shaft of the second gear and the phase of the second gear based on the detected area of the second gear.

6. The gear mechanism assembly apparatus according to claim 5, wherein a shaft center direction of the second gear is acquired based on the position of the distal end portion and the position of the root portion of the gear shaft of the second gear acquired by the second image processing unit, and the robot is controlled so that a deviation of a holding position of the second gear by the hand is corrected based on the shaft center direction of the second gear.

7. The gear mechanism assembly apparatus according to claim 6, wherein, after the position of the distal end portion and the position of the root portion of the gear shaft of the second gear are acquired by the second image processing unit, the hand is rotated by a previously set angle and the second gear is imaged again by the second imaging device, and the position of the distal end portion and the position of the root portion of the gear shaft of the second gear are acquired again by the second image processing unit based on a secondly imaged image, and then a shaft center direction of the second gear is acquired based on an information of the position of the distal end portion and the position of the root portion of the gear shaft of the second gear acquired over two times, and the robot is controlled so that a deviation of a holding position of the second gear by the hand is corrected based on the shaft center direction of the second gear.

8. The gear mechanism assembly apparatus according to claim 1,
wherein the second gear is provided to an output shaft of a motor,
wherein the hand is configured to grasp the motor, and
wherein an optical sensor for measuring a distance to an object to which the motor is mounted is provided to the hand.

9. The gear mechanism assembly apparatus according to claim 1,
wherein the gear mechanism is a planetary gear mechanism, in which the first gear is a planetary gear of the planetary gear mechanism and the second gear is a sun gear of the planetary gear mechanism.

10. A gear mechanism assembly method of assembling a gear mechanism by fitting a second gear to a first gear using a robot, comprising:
a first gear measuring step of acquiring a fitting position of the second gear in the first gear and a phase of the first gear; and
a second gear measuring step of acquiring a phase of the second gear and a position of a gear shaft,
wherein the gear mechanism is assembled using the robot by controlling the robot based on an information acquired by the first gear measuring step and the second gear measuring step so as to position the gear shaft of the second gear held by a hand of the robot to a fitting position of the second gear in the first gear and also position the phase of the second gear to the phase of the first gear.

11. The gear mechanism assembly method according to claim 10,
wherein the first gear measuring step has a first image processing step of acquiring an image of the first gear using an imaging device provided to the hand and performing an image processing, and
wherein the first image processing step is configured to process an image of the first gear so as to detect an area of the first gear and to acquire the fitting position of the second gear in the first gear and the phase of the first gear based on a detected area of the first gear.

12. The gear mechanism assembly method according to claim 11,
wherein the first gear has a plurality of planetary gears, and
wherein, in the first image processing step, a valley part of the plurality of planetary gears included in an imaged image is extracted based on the area of the first gear, and a center of a circumscribed circle which is circumscribed to a plurality of circular arcs whose point on a circumference is a gravity center of the extracted valley part is set as the fitting position of the second gear in the first gear, and also, based on the center of the circumscribed circle, a direction toward a gravity center of a valley part closest to a contact with the circumscribed circle in any one of the plurality of circular arcs is specified as the phase of the first gear.

13. The gear mechanism assembly method according to claim 11,
wherein the first gear has a plurality of planetary gears, and
wherein, in the first image processing step, a valley part of the plurality of planetary gears included in an imaged image is extracted based on the area of the first gear, and a center of a circumscribed circle which is circumscribed to a plurality of circular arcs whose point on a circumference is a gravity center of the extracted valley part is set as the fitting position of the second gear in the first gear, and also, based on the center of the circumscribed circle, a direction toward a point on a circumference of the circumscribed circle such that a length on the circumscribed circle from a contact with the circumscribed circle in any one of the plurality of circular arcs is equal to a length on a circumference of the circular arc between a gravity center of a valley part existing closest to the contact in the circular arc and the contact is specified as the phase of the first gear.

14. The gear mechanism assembly method according to claim 10,
wherein the second gear measuring step has a second image processing step of acquiring an image of the second gear and performing an image processing, and
wherein, in the second image processing step, an image of the second gear is processed so as to detect an area of the second gear, and a position of a distal end portion and a position of a root portion of the gear shaft of the second gear and the phase of the second gear are acquired based on a detected area of the second gear.

15. The gear mechanism assembly method according to claim 14, wherein a shaft center direction of the second gear is acquired based on the position of the distal end portion and the position of the root portion of the gear shaft of the second gear acquired by the second image processing step, and the robot is controlled so that a deviation of a holding position of the second gear by the hand is corrected based on the shaft center direction of the second gear.

16. The gear mechanism assembly method according to claim 15, wherein, after the position of the distal end portion and the position of the root portion of the gear shaft of the second gear are acquired in the second image processing step, the hand is rotated by a previously set angle and the second gear is imaged again, and the position of the distal end portion and the position of the root portion of the gear shaft of the second gear are acquired again based on a secondly imaged image, and then a shaft center direction of the second gear is acquired based on an information of the position of the distal end portion and the position of the root portion of the gear shaft of the second gear acquired over two times, and the robot is controlled so that a deviation of a holding position of the second gear by the hand is corrected based on the shaft center direction of the second gear.

17. The gear mechanism assembly method according to claim 10,
wherein the second gear is provided to an output shaft of a motor,
wherein the hand is configured to grasp the motor, and
wherein a distance to an object to which the motor is mounted is measured by an optical sensor provided to the hand, and a base coordinate system in the object is generated based on the measurement result.

18. The gear mechanism assembly method according to claim 10, wherein the gear mechanism is a planetary gear mechanism, in which the first gear is a planetary gear of the planetary gear mechanism and the second gear is a sun gear of the planetary gear mechanism.
